(19) United States
(12) Patent Application Publication
(10) Pub. No.: US 2026/0023725 A1
(43) Pub. Date: Jan. 22, 2026

(54) PERSISTENT MANUAL REORDERING IN INTERFACES

(71) Applicant: Formagrid Inc, San Francisco, CA (US)

(72) Inventors: David Wetterrau, New York, NY (US); Matthew Bush, New York, NY (US); Andrew Theodore Kumansley, San Francisco, CA (US)

(21) Appl. No.: 18/779,914

(22) Filed: Jul. 22, 2024

(51) Int. Cl. G06F 16/21

(52) U.S. Cl. CPC G06F 16/213

(57) ABSTRACT

Rows are displayed in a default or initial row order in a first interface. A user manually moves a first row to a new position in the row order. An order metric, such as a fractional index value, is calculated for the new position of the first row and stored in a manual ordering field of the first row. The first row is displayed at the new position to the same or other users using the order metric. The first row may additionally or alternatively be displayed at a position determined using the order metric at a new position in a second interface that displays a subset of the rows displayed in the first interface.

### BACKGROUND

### 1. Technical Field

The subject matter described relates generally to databases and, in particular, to techniques for providing manual reordering of data in interfaces using an order field that can be manipulated and transferred to other interfaces.

### 2. Background Information

Users view and interact with data in databases using interfaces. An interface presents a subset of data from one or more underlying databases to a user. The interface may also include data derived from the database (e.g., values that are dynamically calculated from data in the database). Typically, the data displayed in an interface is sorted in a default order, such as alphabetically or numerically by a selected column in the interface. However, these sort orders are not always convenient or helpful to the user.

### SUMMARY

The above and other problems may be addressed by a database system that enables users to manually reorder rows of data in an interface. The order specified by the user is recorded in an order field for the row within the interface. Because the order is stored in a field, it can be manipulated and referenced by other fields. Thus, for example, row ordering can persist across different instances of the interface, be transferred to other interfaces that display some or all of the same data, or be modified algorithmically. Furthermore, changes in row ordering can trigger other automated functionality, such as notifying individuals associated with the row (e.g., assigned workers in a project management application, appointment attendees in a scheduling application, or inventory managers in a stock management application, etc.).

### BRIEF DESCRIPTION OF THE DRAWINGS

FIG. 1 is a block diagram of a networked computing environment suitable for providing manual reordering of data in interfaces, according to one embodiment.

FIG. 2 is a block diagram of the server of FIG. 1, according to one embodiment.

FIG. 3 is a block diagram of the bases data store of FIG. 2, according to one embodiment.

FIG. 4 illustrates multisource synchronization of three tables of three databases in the bases data store, according to one embodiment.

FIG. 5 is a flowchart of a method for partially synchronizing database tables, according to one embodiment.

FIG. 6 is a flowchart of a method for multisource synchronizing database tables, according to one embodiment.

FIG. 7 is a flowchart of a method for manually reordering rows in an interface, according to one embodiment.

FIG. 8 is a flowchart of a method for propagating a manually-defined row order between interfaces, according to one embodiment.

FIG. 9 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

The techniques described provide for manual reordering of rows of data in interfaces that can be persistent across users and time. In one embodiment, rows are initially sorted according to a default order and any rows that a user manually reorders (e.g., by dragging the row to a different position in the interface) have values added to an order column indicating the rows' new positions. When the same or a different user later accesses the interface (or a different interface that displays some or all of the same data), the rows that have a value in the order field are positioned according to the values in the order column and any remaining rows are ordered according to a default sort order of the interface. Thus, in contrast to conventional approaches, users can use a mix of manual and automatic ordering of rows that can persist across different views of the underlying data and for different users. Furthermore, because the manual ordering in an interface is powered by reading and writing cell values, the ordering may be synchronized for other viewers of the interface substantially in real time without the need for separate reordering messages (the cell value updates can just be synchronized to automatically trigger a reordering operation based on the cell values). These and other benefits can be recognized in view of the disclosure below.

### Example Systems

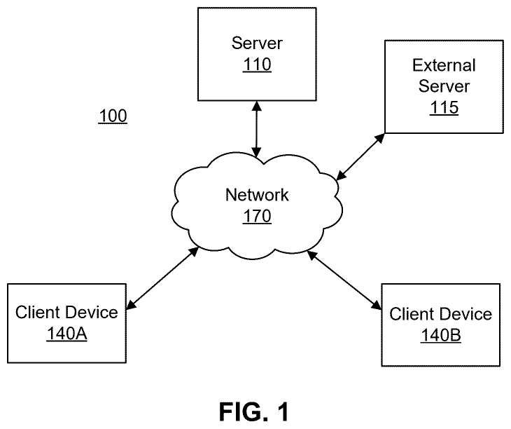

FIG. 1 illustrates one embodiment of a networked computing environment 100 suitable for providing partially synchronized database tables. In the embodiment shown, the networked computing environment 100 includes a server 110, an external server 115, a first client device 140A, and a second client device 140B, all connected via a network 170. Although two client devices 140 are shown, the networked computing environment 100 can include any number of client devices 140. Similarly, although one external server 115 is shown, the networked computing environment 100 can include any number of external servers 115. In other embodiments, the networked computing environment 100 includes different or additional elements. In addition, the functions described herein may be distributed among the elements in a different manner than described.

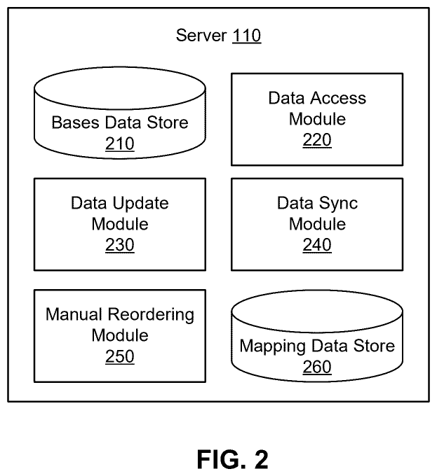

The server 110 hosts multiple databases and provides associated functionality, such as synchronization between databases, data import from external sources, and persistent manual reordering of rows. The manual reordering of rows function enables users to reorder rows that have been sorted according to one or more default rules and have the new order persist. A new row order may persist both for the user that defined it and other users viewing the same data, via the same or different interfaces. As described in further detail below, with reference to FIGS. 2, 7, and 8, persistent manual reordering of rows may be provided by storing an order metric (e.g., a fractional index value) in a column.

The client devices 140 are computing devices with which users can access and edit the databases managed by the server 110. Example client devices include desktop computers, laptop computers, smartphones, tablets, etc. The client devices 140 may enable users to interact with the databases via a user interface accessed via a browser, a dedicated software application executing on the client devices, or any other suitable software.

The external server 115 is a server, which may be associated with a different entity than the server 110. For example, server 110 is associated with a first organization, and server 115 is associated with a second organization. The external server 115 may be, for example, a SALESFORCE server, a JIRA server, a GOOGLE CALENDAR server, or a BOX server. Users of client devices 140 can synchronize data from source tables in databases hosted at the external server 115 to target tables at the server 110. This can involve the user providing credential information, which the server 110 uses to connect to the external server 115.

The server 110 can synchronize data from the external server 115 to a target table in a database of the server 110. In one embodiment, the server 110 stores a tabular data mapping to translate data from the external server 115 to a usable format for server 110 databases. The server 110 may store a different tabular data mapping for each of multiple external servers 115 to facilitate data transfer to the target table. For example, the server 110 may store a first tabular data mapping for SALESFORCE reports that uses a SALESFORCE application programming interface (API), a second tabular data mapping for JIRA issue filters that uses a JIRA API, and a third tabular data mapping for GOOGLE CALENDAR events that uses a GOOGLE CALENDAR API. Using the API of an external server 115, the server 110 can request and receive synchronized data for a target table. For example, the server 110 may send a query to the external server 115 using a respective API function, where the query specifies the data to be synchronized to the target table, and then the server 110 receives, via a different API function, query results including the synchronized data from the external server 115. The server 110 identifies an external server 115, fetches the respective tabular datamapping, and uses the respective tabular data mapping to synchronize data from the external server 115 (e.g., to a target table).

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, all or some of the communication links of the network 170 may be encrypted using any suitable technique or techniques.

FIG. 2 illustrates one embodiment of the server 110. In the embodiment shown, the server 110 includes a bases data store 210, a data access module 220, a data update module 230, a data synchronize module 240, and a mapping data store 260. In other embodiments, the server 110 includes different or additional elements. In addition, the functions may be distributed among the elements in a different manner than described.

The bases data store 210 includes one or more computer-readable media that store the one or more databases managed by the server 110. Although the bases data store 210 is shown as a single element within the server 110 for convenience, the bases data store 210 may be distributed across multiple computing devices (e.g., as a distributed database). Similarly, individual databases may be hosted by client devices 140 (or other computing devices) with the server 110 managing synchronization between databases but not storing the databases themselves.

The data access module 220 provides a mechanism for users to access data in one or more databases. In one embodiment, the data access module 220 receives a request from a client device 140 indicating an identifier of the requesting user (e.g., a username or user identifier) and data from a specified table in a specified database that the user wishes to view. The data access module 220 determines whether the user has permission to access the requested data and, if so, provides it to the client device 140 from which the request was received for display to the user.

The data update module 230 provides a mechanism for creators and their collaborators to edit data in and add data to databases. In one embodiment, the data update module 230 receives a request from a client device 140 indicating an identifier of the requesting user and data to be added to or amended into a specified table in a specified database. The data update module 230 determines whether the requesting user has permission to edit the specified table and, if so, updates the specified table in the bases data store 210 as requested.

The data synchronize module 240 updates some or all portions of target tables to synchronize them with the corresponding source table (or tables). In one embodiment, the data synchronize module 240 periodically (e.g., for a length of time ranging from one second to one hour, such as every five minutes, every hour, etc.) checks the one or more source tables and, if there is updated data available, imports it into the corresponding one or more target tables (e.g., updates records in the target table with respective records from the source table). Additionally or alternatively, users of a target table may force a manual synchronization to one or more source tables (e.g., by selecting a control in the user interface).

In one embodiment, data in the target table matches the format of the data in the shared view interface. For example, if linked records are rendered as text in shared views, they also render as text in the target table. Formulas may render as their result type and look like a non-formula field. As a consequence of this design, synchronization does not differentiate between data being deleted from the source table or simply being hidden from the shared view. As described in further detail below, matching data from source to target table can follow an alternative technique.

The following table illustrates the mapping between source and target data types for one embodiment:

| Source type | Target type |
|---|---|
| Number/date/single-line text/ | Identical type and configuration |
| long text/rich text/select/ | (e.g,. number/date formatting, |
| multi-select | select color and order) |
| Foreign key | Text |
| Collaborator/Multi-collaborator | Text |
| Lookups | As the looked-up type (so |
| | synchronizing a lookup of a |
| | foreign key will result in text) |
| Formulas/Rollups | As the result type |
| Button fields | ‘Open URL’ type button fields |
| | will be synchronized as URL field |
| Attachments | As-is |

A synchronized target table mirrors the contents of its source view but can contain additional unsynchronized columns to enrich the synchronized data. For example, one might collect T-shirt sizes for all employees by synchronizing into the target table a list of employees and then adding an unsynchronized ‘T-shirt size’ column, where each employee enriches the target table by entering their T-shirt size to a respective row at the ‘T-shirt size’ column.

In one embodiment, users of the target table are not allowed to create or destroy records in the synchronized portion of the table, nor to change cell values or column type and type options for any synchronized column, but they can make changes to non-synchronized columns. In some embodiments, users of the target table may change the names and descriptions for synchronized columns, which does not impact the source table (i.e., source view) but changes how the synchronized data is displayed in the target table (e.g., a column in the target table has a different name than the corresponding column in the source table).

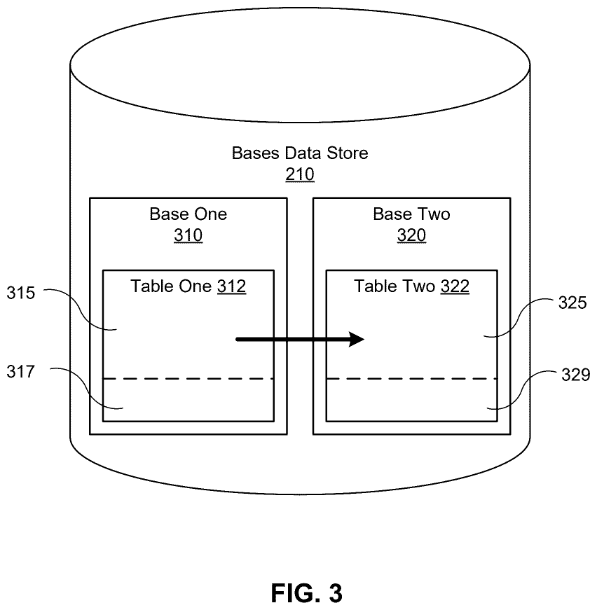

FIG. 3 illustrates the partial synchronization of two tables of two databases in the bases data store 210, according to one embodiment. In the embodiment shown, the bases data store 210 includes base one 310 and base two 320. In practice, the bases data store 210 will likely include many more (e.g., hundreds, thousands, or even millions of) bases. Base one 310 includes table one 312, which has a synchronized portion 315 and an unsynchronized portion 317. Base two 320 includes table two 322, which includes a synchronized portion 325 (which mirrors the synchronized portion 315 of table one 312 except for any differences that arose since the previous synchronization operation) and an enriched portion 329. The enriched portion 329 may include data added by users of base two 320, data synchronized from a third table, or both.

The third table in such a case may either be another table in base one 310 or from a third base (not shown). It should be noted that table two 322 is not limited to receiving synchronized data from just two tables. In theory, table two 322 may receive synchronized data from an unlimited number of other tables, limited only by computational and memory requirements. Similarly, synchronization is not limited to a single generation. Table two 322 may serve as a source table for a third destination table, which may in turn serve as a source table for another target table, etc. Furthermore, each synchronization relationship between a source table and a target table may share a different subset of data selected from either the synchronized portion 325, the enriched portion 329, or both.

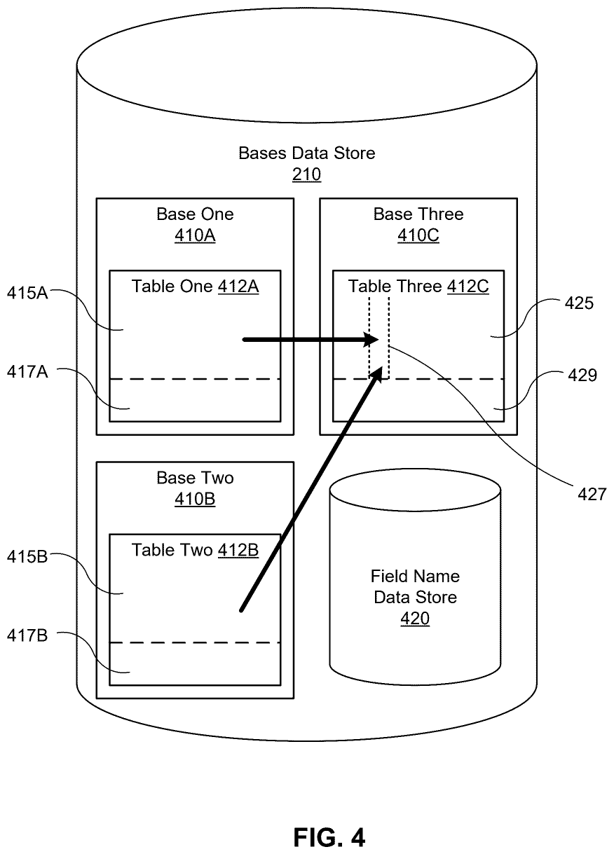

FIG. 4 illustrates multisource synchronization of three tables of three databases in the bases data store 210, according to one embodiment. In the embodiment shown, the bases data store 210 includes base one 410A, base two 410B, base three 410C, and a field name data store 420. Base one 410A includes table one 412A, which has a synchronized portion 415A and an unsynchronized portion 417A. Base two 410B likewise includes table two 412B, which has a synchronized portion 415B and an unsynchronized portion 417B. The field name data store 420 stores mappings between potential field names that have a high likelihood of being synonymous (e.g., “first name” and “given name”). The bases data store 210 may include additional bases or tables, depending upon the embodiment.

Base three 410C includes table three 412C, which includes a synchronized portion 425 and an enriched portion 429. The enriched portion 429 may include data added by users of base two 410B, data synchronized from a fourth table, or both. For example, the server 110 may receive user input data (e.g., data that a user input to a client device 140 and sent to the server 110) specifying additional one or more rows or columns to add to table three 410C.

In this embodiment, table three 412C includes a column 427 that synchronizes data from two sources, table one 412A and table two 412B. For example, column 427 includes ten records total, six received from table one 412A and four from table two 412B. A user administrating table three 412C (e.g., using a client device 140) sets table one 412A as the primary source. Depending upon the embodiment, the primary source may be automatically set by the server 110, e.g., based on which source is first synchronized to the column 427, or which source provides the most records to the column 427; the automatically set primary source may be updated by the user, in some embodiments. Source tables other than the primary source may be considered secondary sources.

The server 110 uses the primary source to determine the data type of the column 427. Data from other sources, e.g., table two 412B, is cast to the data type of the data from the primary source in the column. This resolves ambiguities which may arise from synchronizing columns of multiple source tables with different data types to one column in a target table.

For example, the column synchronized from table one 412A to the column 427 may have a data type “text,” where the column synchronized from table two 412B to the column 427 may have a data type “date.” Because table one 412A is the primary source, the server 110 sets column 427 as having data type “text” and casts data from table two 412B for column 427 as “text.”

The server 110 may also determine the field configuration for the column 427 based on the respective field configuration of the column at the primary source from which data is synchronized. In one embodiment, the primary source determines whether the column in the target table is removed when the source table's column is hidden or destroyed. For example, if a column of a primary source is removed from the source table, the server 110 removes the respective column from the target table, but if the corresponding column is removed from a different source table, only records in the target table corresponding to the different source table are affected (e.g., removed). For a target table with a single source table, the single source table can be considered to be the primary source for all fields.

The user also performs field mapping for synchronized fields from table one 412A and table two 412B to table three 412C. In the field mapping, the user sets a correspondence between a column at each source to a column at table three 412C. The server 110 initially attempts to match fields from sources to table three 412C according to field name, which the user can override via a user interface. The server 110 compares field names from synchronized columns of a source (e.g., table one 412A) to field names of synchronized columns in the target table (e.g., table three 412C) and, upon identifying a matching pair, maps the source field to the target field.

For example, table one 412A may include a “first name” field and a “last name” field, table two 412B may include a “given name” field, a “middle name” field, and a “surname” field, and table three 412C may include a “first name” field and a “family name” field. The server 110 matches the “first name” field from table one 412A to the “first name” field from table three 412C, indicating that data from the “first name” field of table one 412A will synchronize to the “first name” field of table three 412C. The user maps the “given name” field of table two 412B to the “first name” field of table three 412C, and the “last name” field of table one 412A and the “surname” field of table two 412B to the “family name” field of table three 412C. As such, data from table one 412A and table 412B will synchronize to the mapped fields in table three 412C.

In one embodiment, the server 110 auto-matches columns with synonymous field names, as determined according to the field name data store 420. The field name data includes mappings between field names that are likely to be synonymous. Thus, the server 110 can use the field name data to identify columns with different but synonymous names as likely matches. The matches can be automatically applied or presented to the user as suggestions for verification.

Referring back to FIG. 2, the manual reordering module 250 provides functionality within a user interface for users to reorder (e.g., drag and drop) rows into a desired order. Rows may initially be sorted in a default or automatic order. For example, rows may be sorted alphanumerically, chronologically, or by any other sorting rule according to the values in a user-selected or default column. The user may then drag and drop one or more rows to different positions in the order.

In one embodiment, the manual reordering module 250 calculates an order metric (e.g., a fractional index value) for a moved row and stores it in an order field of the row. The order metric is calculated such that it is higher than the order metric for the row immediately on one side of the moved row's new position and lower than the order metric for the row immediately on the other side of the moved row's new position. The column containing the order metrics may be hidden from view by default and may be sparse, containing order metrics for only rows that have been manually ordered. For example, when the first row is reordered, the reordering module 250 may “freeze” the order of the currently visible rows by computing and writing fractional index values for all visible rows. Alternatively, the order column may include an order metric for every row.

Various approaches to storing the order metric may be adopted. For example, the order value may be stored in a text column, a numerical column, or using a column having a dedicated manual ordering data type. Using a text column makes it easy for users and functions to update values stored in the column using conventional create, read, update, and delete (CRUD) actions. Similarly, numerical columns are easily manipulated using conventional CRUD actions. Conversely, using a dedicated data type requires defining the properties of the new data type but allows for specialized handling in the data layer that can improve efficiency and prevent undesirable manipulations of the stored values, such as users accidentally editing the manual ordering column values. For example, the storage of values in the backend may be optimized for a custom data type, which may also be configured to enable rebalancing (e.g. if the index gets longer than a threshold maximum length it may be recalculated and optimized for the current state). In some embodiments, the manual ordering column is marked in the table (either through the use of a dedicated data type or setting a value elsewhere in the table), enabling the manual ordering column to have default behaviors applied to it, such as making it hidden by default in visualizations and de-emphasizing it in column selector interfaces (e.g., by putting it last).

Regardless of precisely how the order values are calculated and stored, when a visualization of the data is rendered, the manual ordering column is included as one to sort by, and thus the results retrieved from the underlying database will be ordered according to the user's intent. If a visualization is generated that includes manually ordered rows and non-manually ordered rows, then the now manually ordered rows may be sorted according to a default or specified sort order and be positioned above or below the manually ordered rows. In one embodiment, the order values are calculated in reverse such that rows that are not manually sorted (and thus have a null order value) appear at the end of the list rather than the start. This ordering is based on the assumption that the user will be more likely to be interested in rows they have sorted manually than those they have not.

To give some examples of how the reordering module 250 may operate, in a first example, a table has a list of tasks [A,B,C,D] that is initially ordered alphabetically. Alice is looking at a filtered list of the tasks including just tasks A and C while Bob is looking at the complete set of tasks. Alice moves task C in front of (above) task A. The reordering module 250 calculates a new fractional index value for C that is less than A's value. Thus, Alice now sees C before A in her list and Bob sees [C, A, B, D] in his list. The manual reordering of the tasks may push an order update to Bob's client device 140 or it may be propagated when Bob's client device 140 next updates its view, depending on the configuration.

In a second example, a table has a pair of manually ordered rows, A and B. A's fractional index value is less than B's so A initially appears before B. A new row, C, is made visible (either by creation or a change in filtering). C initially does not have a fractional index value so is sorted with a null value and appears at the end (or alternatively the beginning) of the list. As described previously, if the fractional index values are calculated in reverse relative to conventional approaches then any rows with a null order value will automatically be sorted after those with assigned fractional index values by the ordering function. Thus, the displayed order will be [A, B, C].

In a third example, a list view includes two projects, P1 and P2. P1 has an ordered set of child tasks, [A, B, D] while P2 also has an ordered set of child tasks, [B, C, D]. Alice move task D in P1 to be before task A, resulting in D being assigned a fractional index value less than that of A. This results in project one having a new task order of [D, A, B]. However, because D also appears in P2 and was moved ahead of B as well as A, the task order for P2 is also impacted. Specifically, because D has a fractional index value less than A, and A has a fractional index value less than B, the new task order for P2 is [D, B, C]. Thus, if A were later added to P2, it could be added in the correct position relative to the other elements without having to reorder any of the other elements.

In one embodiment, the reordering module 250 uses a dedicated CRUD action to compute and save manual ordering updates. The CRUD action will typically be available to all editors of the data within a visualization (not just builders), so that all editors can manually re-order items, although the CRUD action could be limited to users assigned a specific reordering permission. The CRUD action may take in a queryId that the user has visible to enable the reordering module 250 to persist the initial ordering for all visible rows, not just the one that the user moves. The CRUD action may also toggle a value in the visualization (e.g., a flag) indicating that queries for that visualization should sort by the manual ordering column instead of the default sort rule. This can reduce latency as is prevents the manual reordering module 250 needing to check every row that might be returned by a query for a manual ordering value to determine whether the order value column is needed. The manual ordering module 250 can unset this toggled value if a new automatic or default sort is applied to the visualization that overrides the manual reordering.

The mapping data store 260 includes one or more computer-readable media that store tabular data mappings for one or more external servers 115. Although the mapping data store 260 is shown as a single element within the server 110 for convenience, the mapping data store 260 may be distributed across multiple computing devices (e.g., as a distributed database).

### Example Synchronization Methods

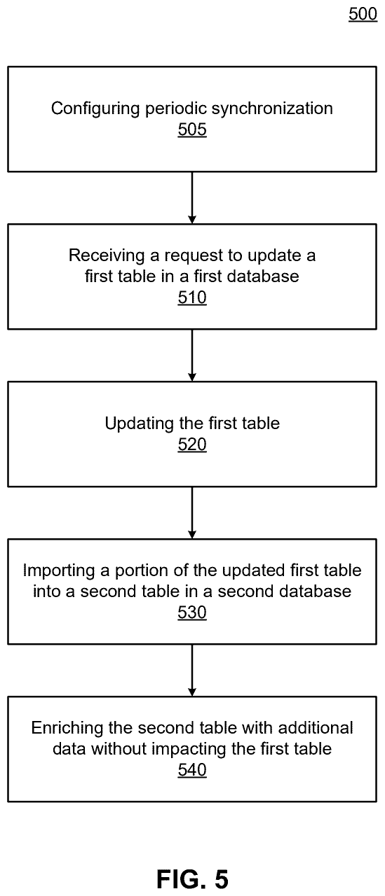

FIG. 5 illustrates a method 500 for partially synchronizing database tables, according to one embodiment. The steps of FIG. 5 are illustrated from the perspective of the server 110 performing the method 500. However, some or all of the steps may be performed by other entities or components. In addition, some embodiments may perform the steps in parallel, perform the steps in different orders, or perform different steps.

In the embodiment shown in FIG. 5, the method 500 begins with the server 110 configuring 505 a periodic synchronization between a first database and a second database. This may be prompted by the server 110 receiving a request to do so. The server 110 receives 510 a request to update a first table in a first database. The server 110 updates 520 the first table as requested. As part of a synchronization operation (either periodic or manually triggered), the server 110 imports 530 a portion of the updated first table into a corresponding portion of a second table in a second database. Depending upon the embodiment, the portion of the updated first table imported 530 to the second table may include only the subset of data of the updated first table that has changed since a previous synchronization operation, or the portion may include all data designated for synchronization from the first table to the second table. The server 110 also enriches 540 the second table with additional data without impacting the first table. As described previously, the additional data may be imported from another table, entered by a user of the second database, or both.

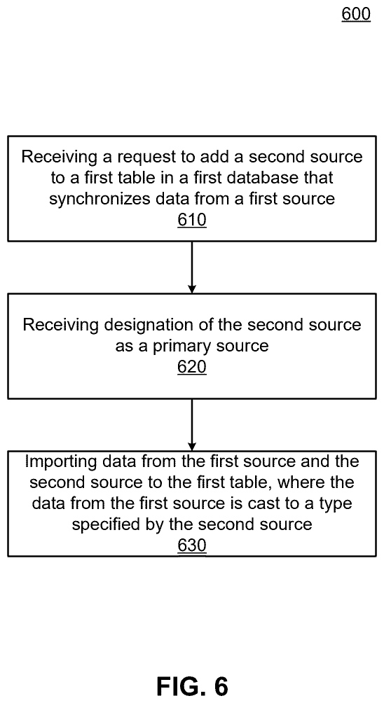

FIG. 6 illustrates a method 600 for multisource synchronizing database tables, according to one embodiment. The steps of FIG. 6 are illustrated from the perspective of the server 110 performing the method 600. However, some or all of the steps may be performed by other entities or components. In addition, some embodiments may perform the steps in parallel, perform the steps in different orders, or perform different steps.

In the embodiment shown in FIG. 6, the method 600 begins with the server 110 receiving 610 a request to add a second source to a first table in a first database that synchronizes data from a first source. The server 110 receives 620 a designation of the second source as a primary source. As such, data from the first source that is synchronized to portions of the first table where data from the second source also syncs will be cast to the data type of the data received from the second source for that portion and configured according to a field configuration of the data received from the second source for that portion. The server 110 imports 630 data from the first source and the second source to the first table, where data from the first source is cast to the type specified by the second source.

### Example Manual Reordering Methods

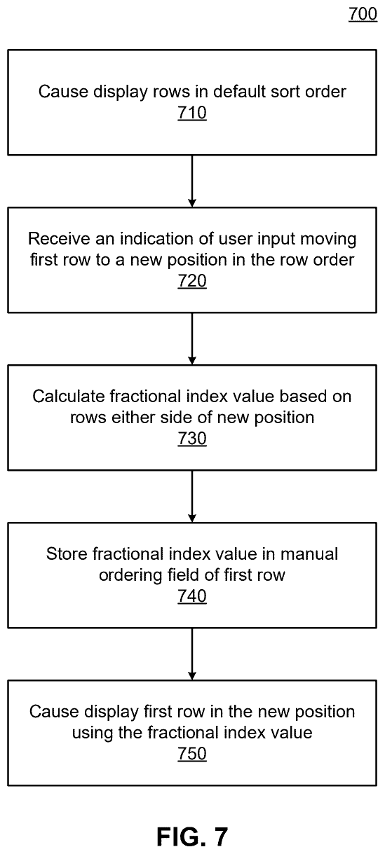

FIG. 7 illustrates a method 700 for manually reordering rows in an interface, according to one embodiment. The steps of FIG. 7 are illustrated from the perspective of the reordering module 250 performing the method 700. However, some or all of the steps may be performed by other entities or components. For example, the method 700 may be performed locally by a client device 140 displaying a visualization with the calculated ordering values being sent to the server 110 to update the database. In addition, some embodiments may perform the steps in parallel, perform the steps in different orders, or perform different steps.

In the embodiment shown, the method 700 begins with the reordering module 250 causing 710 display of rows in a default sort order (e.g., at a client device 140 of a user). The rows can be displayed in a visualization and be a filtered subset of the rows in a table that is returned by a query. The default sort order may be sorting the rows according to the values in one or more columns selected either by default or by the user for ordering the rows. The reordering module 250 receives 720 an indication of user input moving a first row to a new position in the row order. For example, the user may drag and drop the fourth row to between what was initially the first and second rows (making it the second row), etc., and the reordering module 250 receives data indicative of the drag and drop operation performed by the user.

The reordering module 250 calculates 730 an order metric (e.g., a fractional index value) based on the rows on either side of the new position. In one embodiment, the order metric has a value that is between the order metrics of the rows on either side of it. If the first row is moved to be the first row displayed, the order metric may be set to a minimum or maximum possible value, as appropriate for the position of the row. For example, if rows higher in the order have a higher order metric, the order metric for the first row may be set to the maximum value (e.g., one) while if higher rows have lower order metrics, the order metric for the first row may be set to a minimum value (e.g., zero). Similarly, the bottom row can be assigned a maximum or minimum value, as appropriate.

The reordering module 250 stores 740 the calculated order metric in a manual ordering field of the first row. Similarly, the reordering module 250 may store order metrics for other displayed rows to reflect their position relative to the first row (and the other displayed rows). The reordering module 250 then causes 750 the first row to be displayed at the new position using the order metric. For example, if the original user closes the visualization and reopens it later, the reordering module 250 cause 750 the first row to still be displayed (e.g., at a client device 140) in the position the user previously moved it to using the order metric. Similarly, if a different user opens the same or a different visualization including the first row, the reordering module 250 causes 750 the first row to be displayed at the position indicated by the order metric, not the position determined using the default sort order.

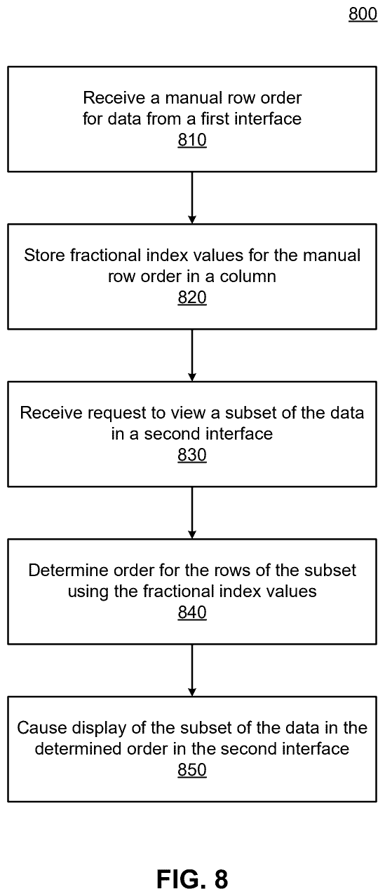

FIG. 8 illustrates a method 800 for propagating a manually-defined row order between interfaces, according to one embodiment. The steps of FIG. 8 are illustrated from the reordering module 250 performing the method 800. However, some or all of the steps may be performed by other entities or components. In addition, some embodiments may perform the steps in parallel, perform the steps in different orders, or perform different steps.

In the embodiment shown, the method 800 begins with the reordering module 250 receiving 810 (e.g., from one or more client devices 140) a manual row order for data in a table from a first interface. The manual row order may be defined by one or more users moving (e.g., dragging and dropping) one or more rows to desired positions in the first interface at one or more corresponding client devices 140. The reordering module 250 stores 820 order metrics (e.g., fractional index values) indicating the manual order in a column of the table.

At a later time, the reordering module 250 receives 830 a request to view a subset of the data in a second interface (e.g., from a client device 140). The subset can include some or all of the data. The second interface may also display rows that are not included in the data form the first interface that are displayed in conjunction with the data from the first interface. The reordering module 250 determines 840 an order for the rows of the subset using the stored order metrics and causes 850 display of the subset of the data in the determined order in the second interface (e.g., at the client device 140). Thus, the order for the rows may be changed by one user in the first interface with the reordering automatically propagating for display to a second user in the second interface.

### Computing System Architecture

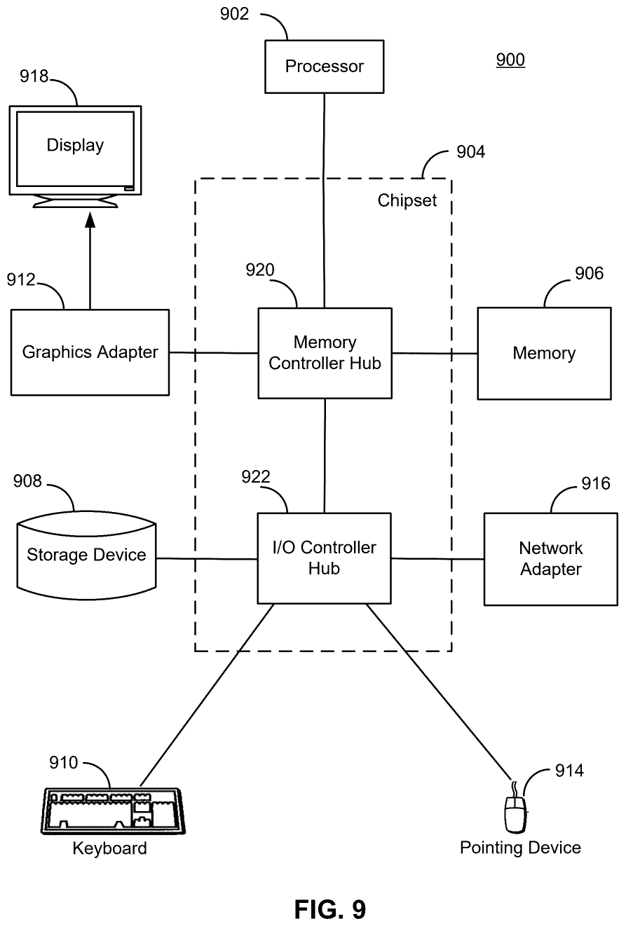

FIG. 9 is a block diagram illustrating an example computer 900 suitable for use as the server 110, the external server 115, or a client device 140. The example computer 900 includes at least one processor 902 coupled to a chipset 904. The chipset 904 includes a memory controller hub 920 and an input/output (I/O) controller hub 922. A memory 906 and a graphics adapter 912 are coupled to the memory controller hub 920, and a display 918 is coupled to the graphics adapter 912. A storage device 708, keyboard 710, pointing device 714, and network adapter 716 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touchscreen, or other type of pointing device, and is used in combination with the keyboard 910 (which may be an on-screen keyboard) to input data into the computer system 900. The graphics adapter 912 displays images and other information on the display 918. The network adapter 916 couples the computer system 900 to one or more computer networks (e.g., network 170).

The types of computers used by the entities of FIGS. 1 through 4 can vary depending upon the embodiment and the processing power required by the entity. For example, the server 110 might include a distributed database system comprising multiple blade servers working together to provide the functionality described. Furthermore, the computers can lack some of the components described above, such as keyboards 910, graphics adapters 912, and displays 918.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

1. A computer-implemented method for persistent manual reordering of rows, the computer-implemented method comprising:
receiving, from a first client device, data indicative of user input moving, within a first interface, a first row of a plurality of rows from a first position in a row order of the plurality of rows to a second position in the row order of the plurality of rows;
calculating an order metric for the first row based on order metrics of rows either side of the second position in the row order of the plurality of rows, wherein the order metric for the first row has a value between values of the order metrics of the rows either side of the second position;
storing the order metric for the first row in a manual ordering field of the first row, wherein the manual ordering field is part of a manual ordering column that is sparse; and
causing a second client device to display the first row in the second position using the order metric.

2. The computer-implemented method of claim 1, further comprising causing display of the first row in a second interface at a third position, the third position determined using the order metric.

3. The computer-implemented method of claim 1, wherein the order metric is a fractional index value.

4. The computer-implemented method of claim 1, wherein the order metric is calculated such that a third row that has not been manually reordered, and has no corresponding order metric stored in the manual ordering column, appears after the first and second rows.

5. The computer-implemented method of claim 1, wherein the manual ordering field uses a custom data type, the computer-implemented method further comprising rebalancing the order metric responsive to the order metric being larger than a threshold length.

6. The computer-implemented method of claim 1, wherein the manual ordering field is not displayed in conjunction with the first and second rows.

7. The computer-implemented method of claim 1, wherein the first row comprises an additional field, the value of which is set by an equation that uses the ordering metric in the manual ordering field.

8. The computer-implemented method of claim 1, wherein the manual ordering column being sparse means that the manual ordering column includes manual ordering metrics for only rows that have been manually reordered, and wherein rows that have not been manually reordered are ordered according to a default sort order.

9. A non-transitory computer-readable medium comprising stored instructions for persistent manual reordering of rows, the instructions, when executed by a computing system, causing the computing system to perform operations including:
receiving, from a first client device, data indicative of user input moving, within a first interface, a first row of a plurality of rows from a first position in a row order of the plurality of rows to a second position in the row order of the plurality of rows;
calculating an order metric for the first row based on order metrics of rows either side of the second position in the row order of the plurality of rows, wherein the order metric for the first row has a value between values of the order metrics of the rows either side of the second position;
storing the order metric for the first row in a manual ordering field of the first row, wherein the manual ordering field is part of a manual ordering column that is sparse; and
causing a second client device to display the first row in the second position using the order metric.

10. The non-transitory computer-readable medium of claim 9, wherein the operations further include causing display of the first row in a second interface at a third position, the third position determined using the order metric.

11. The non-transitory computer-readable medium of claim 9, wherein the order metric is a fractional index value.

12. The non-transitory computer-readable medium of claim 9, wherein the order metric is calculated such that a third row that has not been manually reordered and has no corresponding order metric stored in the manual ordering column, appears after the first and second rows.

13. The non-transitory computer-readable medium of claim 9, wherein the manual ordering field uses a custom data type, the operations further including rebalancing the order metric responsive to the order metric being larger than a threshold length.

14. The non-transitory computer-readable medium of claim 9, wherein the manual ordering field is not displayed in conjunction with the first and second rows.

15. The non-transitory computer-readable medium of claim 9, wherein the first row comprises an additional field, the value of which is set by an equation that uses the ordering metric in the manual ordering field.

16. The non-transitory computer-readable medium of claim 9, wherein a dedicated CRUD action is used to store the order metric in the manual ordering field.

17. A computing system comprising:
one or more processors; and
one or more non-transitory computer-readable media comprising stored instructions for persistent manual reordering of rows, the instructions, when executed by the one or more processors, causing the computing system to perform operations including:
receiving, from a first client device, data indicative of user input moving, within a first interface, a first row of a plurality of rows from a first position in a row order of the plurality of rows to a second position in the row order of the plurality of rows;
calculating an order metric for the first row based on order metrics of rows either side of the second position in the row order of the plurality of rows, wherein the order metric for the first row has a value between values of the order metrics of the rows either side of the second position;
storing the order metric for the first row in a manual ordering field of the first row, wherein the manual ordering field is part of a manual ordering column that is sparse; and
causing a second client device to display the first row in the second position using the order metric.

18. The computing system of claim 17, wherein the operations further include causing display of the first row in a second interface at a third position, the third position determined using the order metric.

19. The computing system of claim 17, wherein the order metric is a fractional index value calculated such that a third row that has not been manually reordered appears after the first and second rows.

20. The computing system of claim 17, wherein the first row comprises an additional field, the value of which is set by an equation that uses the ordering metric in the manual ordering field.
